(19) United States
(12) Patent Application Publication
(10) Pub. No.: US 2006/0257528 A1
(43) Pub. Date: Nov. 16, 2006

(54) Processed soybean and process for producing the same

(76) Inventor: Toru Akazawa, Takarazuka-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/569,098

(22) PCT Filed: Apr. 14, 2004
(86) PCT No.: PCT/JP04/05343

§ 371 Date: Feb. 22, 2006

(51) Int. Cl. A23F 3/16

(52) U.S. Cl. 426/52

(57) ABSTRACT

A method of producing a processed soybean is provided, in which soybean can be decomposed into soybean single cells in a shorter treatment time than before. This method includes the step of performing an enzyme treatment to the soybean in the presence of water by use of, as the enzyme, at least one of cellulase and hemicellulase, and preferably the hemicellulase produced by Trichoderma sp., thereby decomposing the soybean into individual soybean single cells. By this enzyme treatment, it is possible to reduce the production cost, and improve the safety of quality of the processed soybean.

### DESCRIPTION

1. Technical Field

The present invention relate to a method of producing a processed soybean comprising the step of efficiently decomposing soybean into its single cells by use of an enzyme, and the processed soybean obtained by the same method.

2. Background Art

Soybean is a nutritious food material richly containing vitamins and proteins of good quality as well as isoflavone, saponin and lecithin, which are believed to be effective to prevent adult diseases, menopausal disorders and cancer. However, for practical applications in the field of foods, it has been indicated from the past that there are problems that kinds of cooking methods are limited due to a hard epidermal tissue of the soybean, and the above nutritious components are changed in quality or solved out during the cooking operation, so that contents of the nutritious components in the cooked foods decrease.

As disclosed in the PCT International Publication No. WO 01/10242, the present inventor found that the soybean can be decomposed into healthy single cells of the soybean by an enzyme treatment using a pectinase produced by the genus Bacillus without mechanically crushing the soybean. The thus obtained processed soybean liquid and powder remarkably have increased the application possibility of soybean in the field of foods.

However, the above enzyme treatment still has plenty of room for improvement in time needed for the treatment. That is, as the time needed for the enzyme treatment becomes longer, the possibility of generation and propagation of various germs during the enzyme treatment increases. In addition, it leads to an increase in cost of the processed soybean as the final product. Therefore, it is desired to produce the processed soybean in a shorter treatment time than before in order to supply the processed soybean with the stability of quality at a moderate price.

### SUMMARY OF THE INVENTION

From the above viewpoints, a primary concern of the present invention is to provide a method of producing a processed soybean, which has advantages of shortening time needed for an enzyme treatment to reduce the production cost, and improve the safety of quality of the processed soybean.

That is, the production method of the present invention is characterized by comprising the step of performing an enzyme treatment to the soybean in the presence of water by use of at least one of cellulase and hemicellulase, thereby decomposing the soybean into individual soybean single cells.

According to the present invention, it is possible to remarkably shorten the enzyme treatment time needed to decompose the soybean into the soybean single cells, as compared with a conventional enzyme treatment using a pectinase produced by microorganisms of the genus Bacillus. In addition, damages to cell walls and cell membranes of the decomposed soybean single cells are negligibly small, and protein bodies and lipid bodies in the single cells are maintained in a healthy state. Therefore, the processed soybean has a quality at least equal to the processed soybean obtained by the conventional enzyme treatment using the pectinase.

As the enzyme, it is preferred to use at least one of cellulase and hemicellulase produced by the genus of Trichoderma. In this case, since the enzyme treatment can be performed in the neutral region without a pH adjustment, it is possible to avoid that the processed soybean is acidulated. In addition, from the viewpoint of improving the uniformity of the enzyme treatment and providing the processed soybean with a high quality, it is particularly preferred to use the hemicellulase produced by the genus Trichoderma.

In addition, it is preferred that the present method further comprises a particle-size adjusting step of mechanically pulverizing the processed soybean such that protein bodies in the soybean single cells are not broken or crushed. The processed soybean obtained through the particle-size adjusting step is effective to prepare a soybean containing drink, and is characterized in that the protein bodies are maintained in a healthy state, and an average particle size of the processed soybean is in a range of 0.3 μm to 1 μm. In this case, the processed soybean is easily dispersed uniformly in the drink without considerably increasing the soybean smell. In addition, once the processed soybean is dispersed in the drink, it is hard to deposit in the drink. Therefore, there is a further advantage that the drink becomes easy to drink, and does not taste gritty. In the case of performing the particle-size adjusting step, it is preferred to use a homogenizer.

Therefore, a further concern of the present invention is to provide a processed soybean liquid obtained by mechanically pulverizing a slurry, in which the soybean single cells are dispersed, such that the protein bodies in the soybean single cells are not broken. This processed soybean liquid is characterized in that the soybean components having an average particle size of 0.3 μm to 1 μm are dispersed therein. Furthermore, the present invention provides a processed soybean powder having an average particle size of 0.3 μm to 1 μm, which is obtained by mechanically pulverizing the slurry, in which the soybean single cells are dispersed, such that the protein bodies in the soybean single cells are not broken, and then drying a resultant product.

Additional features of the present invention and advantages brought thereby will be understood from the best mode for carrying out the invention and preferred examples described below.

### BRIEF EXPLANATION OF THE DRAWINGS

FIG. 1 is an optical microscope photograph of a processed soybean powder obtained by a production method according to an embodiment of the present invention.

### DETAIL EXPLANATION OF THE INVENTION

A method of producing a processed soybean of the present invention and the processed soybean obtained by the same method are explained below in detail.

The method of producing the processed soybean according to a preferred embodiment of the present invention comprises the steps of soaking soybean in water for a required time period, sterilizing the soybean by heating in the presence of water, cooling the heated soybean at an enzyme treatment temperature, performing an enzyme treatment to the soybean in the presence of water and at least one of cellulase and hemicellulase, and deactivating the enzyme after the enzyme treatment to obtain a processed soybean liquid. If necessary, this production method may comprise a step of drying the processed soybean liquid to obtain a processed soybean powder, and/or a particle-size adjusting step of pulverizing the processed soybean such that protein bodies in the soybean single cells are not broken. Each of these steps is explained below in detail.

First, after a required amount of raw soybean is washed with water, the soybean is soaked in water. This step is performed to supply a sufficient amount of water into individual cells of the soybean, so that the enzyme treatment performed later becomes easy to proceed. The soaking time is not limited. For example, in the present invention using at least one of cellulase and hemicellulase as the enzyme, the soybean can be soaked in water at 50° C. for 1 to 2 hours. In addition, a water amount used in the soaking step can be determined such that a ratio by volume of water to soybean is in a range between 2:1 and 4:1. To more efficiently perform the enzyme treatment, it is preferred to soak the soybean in water containing the cellulase and/or hemicellulase used in the subsequent enzyme treatment.

Next, the soybean is sterilized by heating in the presence of water. This step is performed to deactivate a function of lipoxygenase included in the soybean, and soften an intercellular substance, so that the enzyme treatment performed later becomes easy to proceed. In addition, this step is useful for thermal denaturation of the soybean proteins, so that the digestion and absorption of the soybean proteins in the human body can be improved. To stably achieve these purposes, it is particularly preferred to steam the soybean at 120° C. for 5 to 10 minutes by use of a pressure cooker.

After the steamed soybean is cooled at a predetermined temperature, the enzyme treatment is performed by adding water and at least one of cellulase and hemicellulase. For example, it is preferred that the steamed soybean is cooled at about 50 to 60° C., which is suitable for the enzyme treatment. In addition, it is preferred to use the water used in the soaking step described above in the enzyme treatment from the viewpoint of zero emission of preventing the occurrence of wastewater or waste products as far as possible during the production of the processed soybean. Furthermore, it is preferred that the additive amount of water is determined such that a ratio by volume of water to soybean is in a range between 2:1 and 4:1. The enzyme treatment is preferably performed in the neutral region.

It is preferred to perform the enzyme treatment, for example, at 50° C. for 5 to 10 minutes, while preferably agitating. The most important feature of the present invention is to use at least one of cellulase and hemicellulase, and particularly cellulase and/or hemicellulase produced by Trichoderma sp. In this case, there is an advantage of remarkably reducing the enzyme treatment time, as compared with a conventional case of performing the enzyme treatment with a pectinase produced by the genus Bacillus, while maintaining the quality of the processed soybean in an equal level to the conventional case. By the reduction in enzyme treatment time, it is possible to effectively prevent the generation and propagation of various germs during the production of the processed soybean, and reduce the production cost.

Agitating is effective to further reduce the enzyme treatment time. However, excessive agitating should be avoided to prevent that the soybean single cells are broken thereby. For example, it is preferred to select a soft agitating condition of rotating a stirring wing at a speed of 20 to 200 rpm in the mixture. In this case, the soybean can be efficiently decomposed into soybean single cells by agitating, and simultaneously the cellulase and/or hemicellulase can uniformly act on the soybean cells. Therefore, a smooth enzyme treatment can be achieved.

In the enzyme treatment of the present invention, for example, it is possible to use cellulase or hemicellulase produced by Aspergillus niger or Trichoderma sp., and preferably the cellulase and/or hemicellulase produced by Trichoderma sp. from the viewpoint of easily controlling the enzyme treatment. That is, when using the cellulase or hemicellulase produced by Aspergillus niger, it is needed to place an environment of the enzyme treatment in an acid region by use of a pH adjuster. Therefore, there is a fear that the processed soybean is acidulated. On the other hand, when using the cellulase and/or hemicellulase produced by Trichoderma sp., the enzyme treatment can be performed in the neutral region. In this case, it is not necessary to use the pH adjuster. Therefore, the processed soybean having good quality and taste can be stably obtained.

It is preferred that an additive amount of cellulase or hemicellulase is in a range of 0.01 to 1 wt %, and more preferably 0.05 to 0.5 wt % with respect to a weight of the soybean measured before the soaking step. When using a mixture of cellulase and hemicellulase as the enzyme, a total amount of them is preferably determined in the above range. When the additive amount is less than 0.01 wt %, it may be difficult to decompose the soybean into the soybean single cells. In addition, there is a tendency that the enzyme treatment time is prolonged. On the other hand, more than 1 wt % of the enzyme may be used. However, a further reduction in the enzyme treatment time will not be obtained. On the contrary, it will lead to an increase in production cost.

Thus, the soybean can be decomposed into the soybean single cells by the enzyme treatment of the present invention without breakage of the soybean cells. A slurry, in which the thus obtained soybean single cells are dispersed, is kept at 50° C. for 15 to 30 minutes for aging. At this time, if necessary, the slurry may be agitated by the stirring wing rotated at a speed of about 20 to 30 rpm. The aging time can be reduced by agitating.

Next, a heat treatment is performed to the slurry to deactivate the enzyme action. For example, it is preferred to heat the slurry at about 90 to 100° C. for 5 to 15 minutes.

A processed soybean powder can be obtained by drying the slurry, in which the obtained soybean single cells are dispersed, according to a flash drying method or a spray drying method. The flash drying method is effective to quickly dry a muddy material to obtain a powder as a dried product, and characterized by providing the muddy material in a hot airflow having a high flow rate, and feeding the muddy material along the hot airflow. This drying method can be performed by use of a so-called flash dryer. In the present invention, for example, it is preferred to select a drying condition of 120° C. and 5 seconds. In addition, when the spray drying method is selected, it is preferred to use a spray dryer.

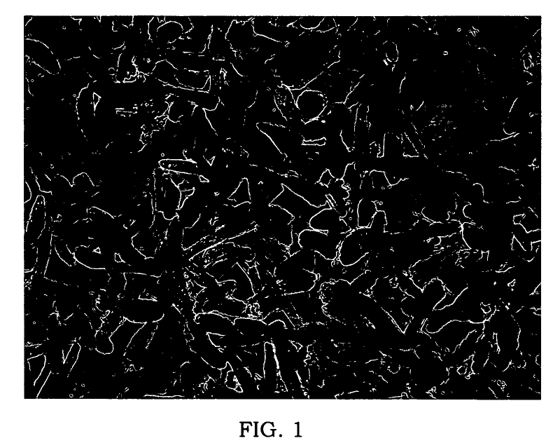

By the production method described above, the processed soybean liquid and powder can be obtained. As an example, an optical microscope photograph of the obtained processed soybean powder is shown in FIG. 1. It shows that damages to the cell walls and cell membranes of the soybean single cells are negligibly small, and protein bodies and lipid bodies in the soybean cells are maintained in a healthy state. In addition, it shows that the soybean single cells are at least equal to them of the processed soybean obtained by the enzyme treatment with the pectinase produced by the genus Bacillus, which is disclosed in the PCT International Publication No. WO 01/10242.

Preferred examples of foods containing the processed soybean liquid or powder of the present invention comprises flour based foods such as spaghetti, macaroni and pasta, prepared meats such as Hamburg and meat balls, soybean foods such as soybean curd and soymilk yogurt, soybean-protein containing foods, breads such as baked roll, Hamburger bun and English muffin, cream, soy paste, vegetarian cheese, cereal, biscuit, cracker, dressing, healthy foods, diet foods such as konnyaku jelly, bean jam, pudding, cream, jam, curry, ice cream, sherbet, and sweets. In addition, preferred examples of a drink containing the processed soybean of the present invention comprises fruit juices, vegetable juices such as carrot juice and tomato juice, coffee, soymilk, and soups such as miso soup and potage soup.

By the way, when the soybean containing drink is prepared by the addition of the processed soybean powder or liquid obtained by the above-described production method, it may difficult to uniformly disperse the soybean single cells having an average particle size of several microns in the drink. In addition, even when the soybean single cells are uniformly dispersed in the drink by shaking a vessel with the soybean containing drink therein, there is a fear that the soybean single cells are immediately deposited. Such an inconvenience easily happens in a drink having a relatively low viscosity such as coffee and lemon juice, as compared with the drink having a high viscosity such as tomato juice and potage soup.

From the viewpoint of providing the soybean containing drink that has good taste and is easy to drink, it is preferred to further perform a particle-size adjusting step of mechanically pulverizing the slurry, in which the soybean single cells are dispersed, such that the protein bodies in the soybean single cells are not broken. In this case, it is important to perform the pulverizing step such that the soybean protein bodies are maintained in a healthy state after the pulverizing step, and an average particle size of the soybean components after the pulverizing step is in a range of 0.3 μm and 1 μm. That is, on the condition that the protein bodies are maintained in the healthy state, the cell walls of the soybean single cells may be partially damaged.

With respect to the average particle size, when it is smaller than 0.3 μm, damages to the protein bodies occur, so that the soybean smell gradually increases. Therefore, the advantages of the soybean single cells may be lost by the particle-size adjusting step. On the other hand, when the average particle size is larger than 1 μm, the effect of preventing the deposition in the drink may not be sufficiently obtained, so that the soybean containing drink tastes gritty and is not easy to drink. When performing the particle-size adjusting step, it is preferred to use a homogenizer. In this case, since composite actions of shearing, collision, cavitation and so on instantaneously happen in the slurry by a combination of plunger pump and valve, a uniform emulsion state can be obtained without the occurrence of flotage and deposition. When using the homogenizer in the particle-size adjusting step, it is preferred to select a two-stage method comprising a first stage performed at a temperature of 50 to 60°C. under a pressure of 30 to 50 kg/cm², and then a second stage performed under a pressure of 150 to 200 kg/cm². In this case, there is an advantage that the average particle size satisfying the above range can be stably obtained.

In the present invention, it is essential to use at least one of cellulase and hemicellulase. However, if necessary, the pectinase produced by microorganisms of the genus Bacillus or the other enzyme may be supplementarily used.

### EXAMPLES

The present invention is specifically explained according to the preferred Examples.

### Example 1

Raw soybean was washed water, and then soaked in water at 50° C. for 60 minutes. At this time, a ratio by volume of water to soybean is 4:1. During the soaking step, 0.1% of hemicellulase produced by Trichoderma sp. with respect to a weight of dried soybean was added to the water. After the soybean was removed (dewatered) from the water used in the soaking step, the soybean was sterilized by heating at 120° C. for 5 minutes. Next, the water containing the enzyme, which was collected at the dewatering step, was added again to the soybean. An enzyme treatment was performed at 50° C. for 5 minutes under an agitating condition of rotating a stirring wing at 200 rpm.

When the soybean is soaked in water, the epidermal layer of the soybean is still hard. Therefore, the enzyme treatment slightly proceeds toward the interior of the soybean. On the other hand, after the soybean is sterilized by heating, the epidermal layer of the raw soybean is softened. Therefore, the enzyme treatment can efficiently proceed toward the interior of the soybean. Next, the rotation speed of the stirring wing was changed to 20 rpm. After a resultant mixture was left at 50° C. for 15 minutes for aging, it was heated and kept at 95° C. for 5 minutes to deactivate the enzyme function. A resultant slurry, in which soybean single cells are dispersed, was dried by means of a spray dryer to obtain a processed soybean powder, which contains the soybean single cells individually decomposed in the healthy state, as shown in FIG. 1.

In the present Example, by using the hemicellulase produced by Trichoderma sp. as the enzyme, only 5 minutes are needed to complete the step of decomposing the soybean into the soybean single cells at 50° C. This treatment time is much shorter than before. This effect can be easily understood from a comparative example performed under the same conditions except for using a pectinase produced by the genus Bacillus as the enzyme.

That is, when the enzyme treatment was performed at 50° C. for 5 minutes by use of the pectinase, soybean cells were separated from each other only in the vicinity of the soybean's surface. However, the enzyme treatment hardly proceeded at a core region of the respective soybean, so that the soybean cells of the core region were still being connected to each other. To investigate the enzyme treatment effect with respect to time, the treatment time was extended. That is, additional enzyme treatments were performed for 10 min, 20 min, 30 min, 60 min and 90 min. As a result, to obtain the processed soybean power equal to that of Example 1, it was needed to perform the enzyme treatment with the pectinase at 50° C. for at least 60 min. In the processed soybean obtained by this enzyme treatment, it was observed that some of the soybean was incompletely decomposed into the soybean single cells. From results of a supplemental experiment, to uniformly decompose the soybean into the single cells, for example, it was effective to modify the condition of the pretreatment, i.e., soak the raw soybean in water for an extended time of 24 hours prior to the enzyme treatment. The extension of the soaking time leads to a reduction in production efficiency of the processed soybean. Therefore, to keep a constant production efficiency, for example, an equipment investment of increasing the number of tanks for the soaking step will be needed. Thus, according to the production method of the present invention, it is possible to reduce the soaking time as well as the enzyme treatment time, and save the cost for production equipments.

Thus, in the case of using the enzyme treatment condition of Example 1, the treatment time of the enzyme treatment with the hemicellulase produced by Trichoderma sp. can be reduced to at least sixth part of the treatment time of the enzyme treatment with the pectinase produced by the genus Bacillus. In addition, the time for the soaking step performed prior to the enzyme treatment can be also reduced. Moreover, the obtained processed soybean has no soybean smell and acid taste. Feeling of eating and appearance of the processed soybean are substantially equal to them of the processed soybean obtained by performing the enzyme treatment with the pectinase produced by the genus Bacillus for the extended time period.

### Example 2

In place of the hemicellulase, soybean was decomposed into soybean single cells under the substantially same conditions of Example 1 except for using cellulase produced by Trichoderma sp. as the enzyme. In this case, the soybean was decomposed into the soybean single cells by performing the enzyme treatment at 50° C. for 1 minute under the agitating condition of rotating the stirring wing at 200 rpm. When using the cellulase, it is possible to further reduce the enzyme treatment time as compared with the case of using the hemicellulase. However, when the enzyme treatment is excessively continued, damages to cell walls of the obtained soybean single cells may occur. Therefore, it is needed to carefully control the enzyme treatment time to prevent the damages. In addition, when the enzyme treatment is performed by use of a large vessel, there is a possibility of causing variations in treatment speed in the large vessel. Therefore, it is needed to well understand the progress of the enzyme treatment in the large vessel to stably obtain the soybean single cells with uniform quality.

By the way, the present Example using the cellulase produced by Trichoderma sp. presents the advantage of reducing the enzyme treatment time, as compared with the case of using the pectinase produced by the genus Bacillus. However, from a comprehensive perspective, it is preferred to use the hemicellulase produced by Trichoderma sp. The treatment speed in the case of using the hemicellulase is slightly slower than that in the case of using the cellulase. However, since the enzyme treatment uniformly proceeds, the quality of the obtained soybean single cells can be easily stabilized. In other words, there is an advantage that the enzyme treatment is easy to control in a remarkably reduced treatment time, as compared with the case of using the pectinase produced by the genus Bacillus.

### Example 3

A soybean containing drink that is easy to drink and tastes good was produced by use of a slurry, in which soybean single cells obtained in Example 1 are dispersed. First, a processed soybean puree was prepared by performing a particle-size adjusting step with use of a homogenizer. The particle-size adjusting step of this Example is composed of two stages. That is, a first stage was performed under the condition of 60° C. and 40 kg/cm², and then a second stage was performed under the condition of 180 kg/cm². As a result, an average particle size of the soybean single cells was reduced from several μm measured before the particle-size adjusting step to about 0.8 μm measured after the particle-size adjusting step. In addition, it was observed with a microscope that although a certain level of damage to the cell walls of the soybean single cells was caused by the particle-size adjusting step, soybean protein bodies having an average particle size of about 0.3 μm are still maintained in a healthy state. Thus, since the damages to the soybean protein bodies are negligibly small, the occurrence of soybean smell was not realized after the particle-size adjusting step.

By use of the obtained processed soybean puree, a coffee drink, soybean soup, and an orange juice were prepared under the following conditions. Taste and a degree of easy-to-drink of them were evaluated.
1) Coffee drink

The coffee drink was prepared by mixing 9.75 g of coffee, 24.5 g of sugar, 9.55 g of the processed soybean puree, and required amounts of glucose, milk powder, baking soda and water, while agitating sufficiently.
2) Soybean soup

The soybean soup was prepared by adding a dried chip of a commercially available consomme soup to 300 g of the processed soybean puree (soybean solid content: 20%), and then dissolving a resultant mixture with a required amount of hot water.
3) Soybean containing fruit juice

The soybean containing fruit juice was prepared by drying the processed soybean puree by use of a spray dryer to obtain a processed soybean powder, adding an orange juice to the processed soybean powder, and then sufficiently agitating a resultant mixture. A mixture ratio (wt %) of the processed soybean powder and the orange juice is 5:95.
4) Soybean containing vegetable juices

The soybean containing vegetable juices were prepared by drying the processed soybean puree by use of a spray dryer to obtain a processed soybean powder, adding the processed soybean powder to each of a carrot juice, tomato juice and a vegetable juice, which are commercially available, and then sufficiently agitating a resultant mixture by use of a mixer for home use. A mixture ratio (wt %) of the processed soybean powder and each of the juices is 5:95.

In addition, comparative drinks were produced according to the same methods described above except for using a soybean slurry, in which soybean single cells are dispersed, prepared without the particle-size adjusting step. Due to a deposition of the soybean single cells, the comparative drinks were hard to drink, and tastes gritty. On the other hand, the drinks of this Example were easy to drink without leaving gritty feeling on the tongue. In addition, the deposition of the soybean components was negligibly small until each of the drinks was finished. In addition, the occurrence of soybean smell was not realized, as in the case of the comparative drinks. Thus, it was confirmed that the particle-size adjusting step is very effective to prepare the drinks containing the processed soybean of the present invention.

### Example 4

In this Example, a nutrition enhanced soybean curd was produced by use of a processed soybean powder, which was obtained by drying the processed soybean puree of Example 3 by a spray dryer. That is, a gelatin plate was firstly soaked in water. The gelatin was then added to about 50 cc of a cow milk, while the cow milk bein heated in a small pan, so that the gelatin was dissolved in the cow milk. After the heating is stopped, required amounts of the cow milk and the processed soybean powder were added, and then uniformly mixed. A resultant mixture was put in a wetted mold, and then cooled and solidified in a refrigerator to obtain the soybean curd of this Example. There was no difference in taste and appearance between the obtained soybean curd and a comparative soybean curd prepared without using the soybean processed powder.

However, a content of isoflavone in the soybean curd of this Example is about 9 times as much as the conventional soybean curd, and a content of dietary fiber in the soybean curd of this Example is about 15 times as much as the conventional soybean curd. In the conventional method of producing the soybean curd, the epidermis and the embryonic axis of soybean are generally removed. On the other hand, the processed soybean of the present invention basically maintains the original proportion of nutritions in raw soybean. Therefore, the dietary fiber richly included in the epidermis of the soybean and the isoflavone richly included in the embryonic axis of the soybean can be efficiently left in the soybean curd. From these reasons, it is believed that the nutritions of the soybean curd can be enhanced.

### Example 5

In this Example, a noodle was produced by use of the processed soybean powder of Example 1. An additive amount of the processed soybean powder is 6% with respect to a total amount of raw powder components including wheat flour. The thus obtained noodle has good feelings of eating. In addition, the occurrence of soybean smell was not realized at the times of making and eating the noodle. Thus, a nutrition-enhanced noodle can be obtained by use of the processed soybean of the present invention.

### Example 6

In this Example, a bread was produced by use of the processed soybean powder of Example 1. First, as listed in Table 1, measured amounts of raw materials were mixed for a required time at a kneading temperature of 28° C. to obtain a dough. This dough was fermented for 100 minutes, and then divided into desired amounts. After the elapse of a predetermined bench time, they were baked under the condition of furnace temperature and humidity of 38° C. and 80%, and a keeping time of 40 minutes to obtain the breads of the present Example.

The thus obtained breads were eat by 5 subjects to check the occurrence of soybean smell. However, no subject realized the occurrence of soybean smell. In addition, since the bread containing the processed soybean powder of the present invention possesses intracellular water “cell water”, it has a greater moisture-retaining capability than the conventional bread not containing the processed soybean. Therefore, a softly baked bread can be obtained.

TABLE 1

| Raw materials | Additive amounts (g) |
|---|---|
| Strong wheat flour | 100 |
| Sugar | 6 |
| Salt | 2 |
| Yeast | 2.7 |
| Processed soybean powder | 10 |
| Compound margarine | 7 |
| Water | 75 |

### Example 7

In this Example, a low-salt soybean paste was produced by use of a soybean processed powder obtained by drying the processed soybean puree of Example 3 by a spray dryer. That is, 50 g of the processed soybean powder and 125 cc of water were added to 500 g of a commercially available soybean paste, and then a resultant mixture was sufficiently mixed to obtain the low-salt soybean paste of this Example. By uniformly mixing the processed soybean powder in the soybean paste, the salt amount per 1 g of the soybean paste is relatively reduced. Therefore, it is possible to provide the low-salt soybean paste, which has a mild taste and is nutrition-enhanced by the processed soybean.

### Example 8

In this Example, a soymilk like drink was produced by use of a soybean processed powder obtained by drying the processed soybean puree of Example 3 by a spray dryer. That is, the processed soybean powder was added to mineral water at a mixture ratio of 30 g to 100 g of the mineral water, and then a resultant mixture was sufficiently mixed by a mixer for home use to obtain the soymilk like drink of the present Example. In this case, it is possible to provide the soymilk like drink, which is low in price and easy to swallow, despite such a large amount of the solid content in the drink.

### INDUSTRIAL APPLICABILITY

Thus, in the method of producing the processed soybean of the present invention, since at least one of cellulase and hemicellulase, and particularly the hemicellulase produced by Trichoderma sp. is used as the enzyme, the enzyme treatment time can be remarkably reduced as compared with the conventional case of using the pectinase produced by the genus Bacillus. Therefore, there are advantages of reducing the production cost, and preventing the generation and propagation of various germs to further improve the safety of quality of the processed soybean. Moreover, the basic concept of the present invention is to provide an ecologically friendly production method from the viewpoint of zero emission of waste products at the time of producing the processed soybean.

1. A method for producing a processed soybean comprising the steps of performing an enzyme treatment to soybean in the presence of water by use of at least one of cellulase and hemicellulase, thereby decomposing said soybean into individual soybean single cells.

2. The method as set forth in claim 1, wherein said enzyme treatment is performed by use of at least one of cellulase and hemicellulase produced by Trichoderma sp.

3. The method as set forth in claim 1, wherein said enzyme treatment is performed by use of hemicellulase produced by Trichoderma sp.

4. The method as set forth in claim 1, wherein an additive amount of said at least one of cellulase and hemicellulase is in a range of 0.01 to 1% of a weight of dried soybean.

5. The method as set forth in claim 1, further comprising the step of mechanically pulverizing a slurry obtained by said enzyme treatment, in which said soybean single cells are dispersed, such that protein bodies in said soybean single cells are not broken.

6. The method as set forth in claim 5, wherein said mechanically pulverizing step is performed by use of a homogenizer.

7. A processed soybean powder having an average particle size of 0.3 μm to 1 μm, which is obtained by mechanically pulverizing a slurry obtained by the method as set forth in claim 1, in which said soybean single cells are dispersed, such that protein bodies in said soybean single cells are not broken, and then drying a resultant product.

8. A processed soybean liquid obtained by the method as set forth in claim 5, in which the protein bodies are maintained in a healthy state, and soybean components having an average particle size of 0.3 μm to 1 μm are dispersed.

9. A processed food produced by adding the processed soybean obtained by the method as set forth in claim 1 to another food material.

10. A drink containing the processed soybean obtained by the method as set forth in claim 5.

11. A noodle containing the processed soybean obtained by the method as set forth in claim 1.

12. A bread containing the processed soybean obtained by the method as set forth in claim 1.

13. A soybean curd containing the processed soybean obtained by the method as set forth in claim 5.

14. A soybean paste containing the processed soybean obtained by the method as set forth in claim 5.
